(19) United States
(12) Patent Application Publication
(10) Pub. No.: US 2010/0208722 A1
(43) Pub. Date: Aug. 19, 2010

(54) NETWORK SYSTEM, PATH CALCULATION METHOD, AND PATH CALCULATION PROGRAM

(76) Inventors: Itaru Nishioka, Tokyo (JP); Yohei Iizawa, Tokyo (JP)

Correspondence Address: Mr. Jackson Chen, 6535 N. STATE HWY 161, IRVING, TX, 75039, US

(21) Appl. No.: 12/738,720

(22) PCT Filed: Oct. 17, 2008
(86) PCT No.: PCT/JP2008/068833

§ 371 Date: Apr. 19, 2010

(30) Foreign Application Priority Data
Oct. 18, 2007 (JP) 2007-271687

(51) Int. Cl. H04L 12/28

(52) U.S. Cl. 370/351

(57) ABSTRACT

A route decision system is arranged in each domain of a multi-domain network. The route decision system comprises a topology information collecting unit which collects topology information, a route calculation request responding unit which receives a route calculation request requesting route calculation of a redundant path from a start node to an end node, and a route calculating unit which performs route calculation in response to the route calculation request using the topology information in consideration of a restriction. After a domain from a starting point domain where the start node is present to an end point domain where the end node is present is set, route calculation of the redundant path is sequentially performed at each domain from the end point domain toward the starting point domain through an intermediate domain.

### TECHNICAL FIELD

The present invention relates to a network system, a route calculation method, and a program, and more particularly, a network system which provides a communication service using a connection-oriented path connection, a route calculation method and a program in such network system.

### BACKGROUND ART

Nowadays, from the standpoint of strict management of a network service, and quality assurance of a communication service, a network which clearly manages the route of the communication service using a connection-oriented path explicit to the communication service becomes widespread. Examples of such connection-oriented path are an MPLS (Multi-Protocol Label Switching) path, an ATM (Asynchronous Transport Mode) path, a connection-oriented Ethernet (registered trademark) path, a TDM path, and a wavelength path. When the connection-oriented path is controlled and managed in such network, in the case of a large-scale network with large number of nodes, it is general that the network is divided into a plurality of domains, and a path is controlled and managed in detail per domain unit because of expandability of the network and improvement of the efficiency in operation. The network divided into a plurality of domains is called a multi-domain network.

In a multi-domain network, detailed topology information used when a path route is set is publicized exclusively in each domain by a routing protocol. It is, however, difficult to calculate most appropriately and collectively a path across a plurality of domains with such partially-detailed topology information only, so that a method of calculating an interval route in each domain, and of acquiring a total route by combining calculation results of respective domains together is employed. In calculating such interval route, it is necessary to consider at least following restrictions:

a route enabling configuration of a bandpass of a required path; and

a current path and a backup path pass through respective routes which do not share the same network resource between a start node (SN) which is a starting point of a path and an end node (DN) which is an end point thereof.

Note that the routes which do not share the same network resource are routes that any one of or all of a node, a link, and an SRLG (Shared Risk Link Group) are not shared between the current path and the backup path. This is called a route diversity.

A path setting method in the above-explained multi-domain network is disclosed in patent literature 1. FIG. 20 shows a network configuration using a route decision system disclosed in patent literature 1. The multi-domain network system comprises a plurality of domains (domain DM1 to domain DMn), a start node 1001 of a path, an end node 1002 thereof, intermediate nodes (T1 to T4) 1004 thereof, and route decision systems (PSS1 to PSS4) 1000 which are connected to respective boundary nodes (BN1 to BN10) 1005 between domains.

In the multi-domain network shown in FIG. 20, when calculating a route from the start node 1001 to the end node 1002, the route decision system operates as follows. The start node 1001 selects the route decision system PSS1 connected to an intermediate domain (assuming that the domain DM3 is selected) which can reach a target domain (domain DM2), and transmits a route calculation requesting message. The route decision system PSS1 selects a boundary node in accordance with a priority order, calculates routes from the start node 1001 to the selected respective boundary nodes 1005 (e.g., selects the boundary node BN1 for a current path, and the boundary node BN3 for a backup path) based on the route diversity of the path, and transmits, together with the route calculation result, a route calculation request to the route decision system PSS3 for a following route from the boundary node BN1 to the end node 1002, and a route from the boundary node BN3 to the end node 1002. The route decision system PSS3 calculates the following of the route calculated by the previous-stage route decision system PSS1 based on the route diversity of the path.

When routes from the start node 1001 to the end node 1002 are settled, information on the calculated routes is transmitted to the start node 1001 of the request originator from the route decision system PSS3 through the route decision system PSS1 as the route for the current path and that for the backup path. The start node 1001 issues signaling for the current path and that for the backup path, respectively, in accordance with information on those routes. Accordingly, the current path and the backup path are set between the start node 1001 and the end node 1002.

When a route calculation is failed, a route decision system which has failed the route calculation or a route decision system at the previous stage of the failed route decision system selects a different boundary node in accordance with priority order information, and starts over the route calculation. This operation is repeated until the route calculation succeeds. An example of failing the route calculation in the network configuration in FIG. 20 is a case in which the route decision system PPS1 selects the boundary node BN1 for a current path, and the boundary node BN2 for a backup path. In this case, in the route calculation by the route decision system PSS3, the current path and the backup path pass through the same node at the intermediate node T1, so that the route decision system PSS3 returns failing a route calculation.

### Patent Literature 1: Unexamined Japanese Patent Application KOKAI Publication No. 2005-252368.

### DISCLOSURE OF INVENTION

### Problems to be Solved by the Invention

According to the route calculation system of the foregoing related art, there are following problems. A first problem is that there may be a case in which it is necessary to start over the selection of a boundary node several times and to perform a route calculation every time the selection is started over in order to set an end-end route between a start node and an end node belonging to different domains, and it takes a large amount of time for the route calculation. The larger the number of domains is and the larger the number of boundary nodes is, the more a time required for the calculation increases, and it becomes a nonnegligible performance issue when the route calculation for a large-scale network comprising a plurality of domains is performed. The reason why the route calculation takes a time is because a boundary node is selected in accordance with a priority, and the restrictions of the route diversity for a current path and that for a backup path are not satisfied depending on a topological shape, so that the number of failures in the route calculation increases.

A second problem is that the optimality of a calculated current path and that of a calculated backup path cannot be guaranteed. The reason why is in order to select a boundary node in accordance with a priority irrelevant to an optimum index, if there is another boundary node which becomes the most appropriate route, the route calculation is performed without any consideration to this route. A third problem is that there is no mechanism of selecting an appropriate domain to be passed through and a route calculation system controlling that domain if there are a plurality of intermediate domains. The reason why is that it is difficult to select a domain or detect a boundary node by merely using conventional routing mechanisms, such as an OSPF and a BGP. For example, when a route decision system does not have the same identifier as that of a boundary node, it is difficult to automatically select such domain.

It is an object of the present invention to provide a network system, a route decision system, a route calculation method and a program which can efficiently calculate redundant paths (a current path and a backup path) satisfying restrictions in a multi-domain network.

### Means for Solving the Problems

The present invention according to a-first aspect provides a network system comprising a plurality of route decision systems which are distributed and arranged in a multi-domain network divided into a plurality of route calculation domains, and wherein each route decision system comprises a topology information collecting unit which collects topology information, a route calculation request responding unit which receives a route calculation request requesting route calculation of a redundant path from a start node to an end node, and a route calculating unit which performs route calculation in response to the route calculation request using the topology information in consideration of a restriction, and after a route calculation domain to be passed through from a route calculation domain where the start node is present to a route calculation domain where the end node is present is set, a route of the redundant path between the start node and the end node is calculated by causing the route calculating unit to sequentially perform route calculation of the redundant path in each route decision system from the route calculation domain where the end node is present toward the route calculation domain where the start node is present, and by combining routes of the redundant path calculated by respective route decision systems together.

The present invention according to a second aspect also provides a route decision system arranged correspondingly to at least one of a plurality of route calculation domains in a multi-domain network comprising a topology information collecting unit which collects topology information, a route calculation request responding unit which receives a route calculation request requesting route calculation of a redundant path from a start node to an end node, a route-decision-system selecting unit which selects a route calculation domain where a route decision system to which the route calculation request is to be transmitted belongs when the end node is not present in a local route calculation domain to which the route decision system belongs, and a route calculating unit which performs route calculation of the redundant path using the topology information in consideration of a restriction when the end node is present in the local route calculation domain to which the route decision system belongs, and issues a route calculation response including a result of the route calculation to a transmission originator of the route calculation request.

The present invention according to a third aspect also provides a method of calculating a route of a redundant path across route calculation domains from a start node to an end node by a plurality of route decision systems which are distributed and arranged in a multi-domain network and which work together, the method comprising a step of setting a route calculation domain through which a route from the start node to the end node passes using adjacency information retained by each route decision system, and a step of causing a route decision system belonging to the set route calculation domain to recursively perform path calculation from a route decision system belonging to a route calculation domain where the end node is present toward a route decision system belonging to a route calculation domain where the start node is present.

The present invention according to a fourth aspect also provides a program allowing a computer to execute a process of calculating a route of a redundant path across route calculation domains from a start node to an end node in a multi-domain network, the program allowing the computer to execute a process of receiving a route calculation request requesting route calculation of the redundant path, a process of selecting a route calculation domain where a route decision system to which the route calculation request is to be transmitted belongs when the end node is not present in a local route calculation domain to which a route decision system belongs, and a process of performing route calculation of the redundant path in consideration of a restriction using topology information when the end node is present in the local route calculation domain to which the route decision system belongs, and of issuing a route calculation response including a result of the route calculation to a transmission originator of the route calculation request.

### EFFECT OF THE INVENTION

The network system, the route decision system, the route calculation method, and the program of the present invention can efficiently calculate redundant paths (a current path and a backup path) satisfying restrictions.

The object and other objects, characteristics, and advantages of the present invention will become apparent by the following explanation with reference to the accompanying drawings.

### BRIEF DESCRIPTION OF DRAWINGS

FIG. 1 is a block diagram showing a network configuration using a route decision system according to a first embodiment of the present invention;

FIG. 2 is a block diagram showing the configuration of the route decision system;

FIG. 3 is a sequence diagram showing a procedure when performing a route calculation of a redundant path by a plurality of route decision systems;

FIG. 4 is a flowchart showing a procedure of a route-decision-system selection process;

FIG. 5 is a block diagram showing an example route where reachability information on the route decision system is notified;

FIG. 6 is a block diagram showing an example route where reachability information on an end node is notified;

FIG. 7 is a diagram showing a specific example of the reachability information;

FIG. 8 is a flowchart showing a procedure of a route calculation process;

FIG. 9 is a block diagram exemplifying a topology in a multi-domain network;

FIG. 10 is a block diagram showing a topology used for a route calculation in an end-point-route calculation domain;

FIG. 11 is a diagram showing candidates of a redundant path calculated in the end-point-route calculation domain;

FIG. 12 is a block diagram showing a topology used for a route calculation in an intermediate-route calculation domain;

FIG. 13 is a diagram showing candidates of a redundant path calculated in the intermediate-route calculation domain;

FIG. 14 is a block diagram showing a topology used for a route calculation in a starting-point-route calculation domain;

FIG. 15 is a diagram showing candidates of a redundant path calculated in the starting-point-route calculation domain;

FIG. 16 is a block diagram showing the configuration of a route decision system according to a second embodiment of the present invention;

FIG. 17 is a sequence diagram showing a procedure when performing a route calculation of a redundant path by a plurality of route decision systems;

FIG. 18 is a flowchart showing a procedure of a route-decision-system selection process according to the second embodiment;

FIG. 19 is a diagram showing the route calculation result of the redundant path according to the second embodiment; and

FIG. 20 is a block diagram showing a network configuration using a route decision system of a related art.

### BEST MODE FOR CARRYING OUT THE INVENTION

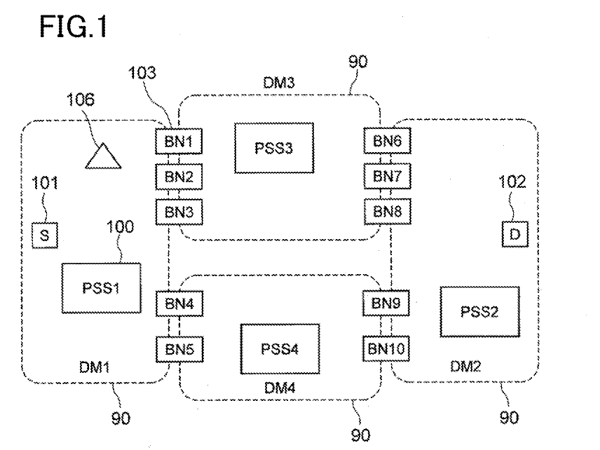

An explanation will be given of embodiments of the present invention in detail with reference to the accompanying drawings. Note that the same reference numeral indicates the same element through the accompanying drawings. FIG. 1 shows a network configuration using a route decision system according to a first embodiment of the present invention. A network is divided into a plurality of domains (domain DM1 to domain DM4). A plurality of boundary nodes 103 (BN: Boarder Node) are arranged between the domains. A plurality of route decision systems (PSS1 to PSS4) 100 are arranged correspondingly to respective domains, and perform route calculation of a corresponding domain. A request originator 106 is a system which issues a route calculation request. The request originator 106 can also operate as a function block in a start node (SN) 101.

Note that, in FIG. 1, although the route decision systems 100 are so configured as to be arranged in respective domains, it is also possible to arrange a route decision system 100 across a plurality of domains. A domain or a collection of a plurality of domains managed by the route decision system 100 is called a route calculation domain 90. In FIG. 1, each of the domains DM1 to DM4 configures the route calculation domain 90.

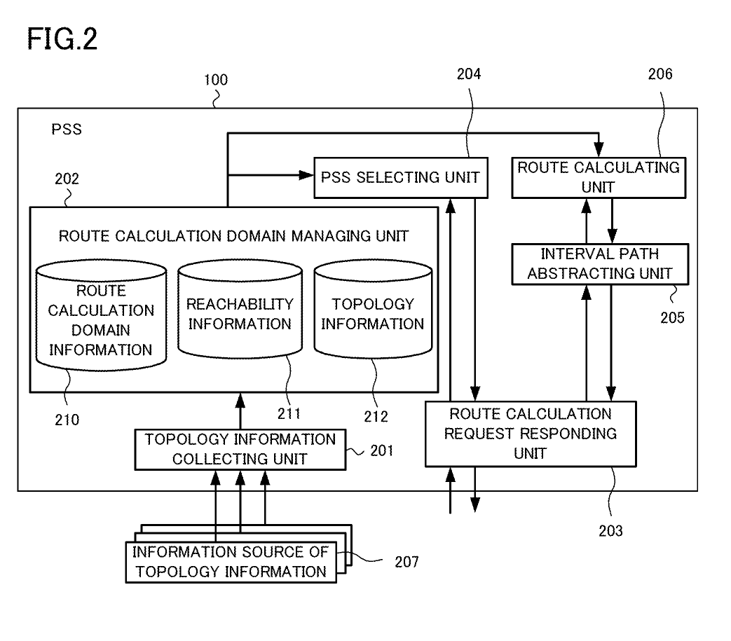

FIG. 2 shows the configuration of each route decision system 100. The route decision system (PSS) 100 includes a topology information collecting unit 201, a route calculation domain managing unit 202, a route calculation request responding unit 203, a route-decision-system selecting unit (PSS selecting unit) 204, an interval path abstracting unit 205, and a route calculating unit 206. The route decision system 100 is configured by a computer system, and the function of each unit in the route decision system 100 is realized by running a program installed in the computer system.

The topology information collecting unit 201 collects detailed topology information in the route calculation domain 90 from one or a plurality of topology information sources 207, and reachability information from the route decision system and reachability information from the node both belonging to another route calculation domain 90. The topology information source 207 in FIG. 2 corresponds to the boundary nodes BN1 to BN10 in FIG. 1, the route decision systems PSS1 to PSS4 of respective domains, and other nodes which are not illustrated. Alternatively, when a managing device which centrally manages the topology information in the domains is provided, the topology information source 207 corresponds to that managing device. The topology information can be collected by a management information collecting protocol like an SNMP (Simple Network Management Protocol), or a routing protocol, such as an OSPF TE (Open Shortest Path First with Traffic Engineering), an IS-IS TE (Intermediate System-Intermediate System with Traffic Engineering), or an IGP (Interior Gateway Protocol).

The route calculation domain managing unit 202 generates route calculation domain information 210, reachability information 211, and topology information 212 based on information collected by the topology information collecting unit 201, and manages those pieces of information as a database. The topology information 212 indicates a detailed topology in the domain. Link information on a link in the domain is included in the topology information 212. The link information includes a node identifier, a link identifier, a remaining bandpass, and a link cost.

The route calculation domain information 210 manages boundary node information on the route calculation domain, and adjacency information between route decision systems. The node identifier is included in the boundary node information, and identifiers of adjoining route decision systems are included in the adjacency information. It is possible to figure out that a domain to which a route decision system belongs is adjoining to which route calculation domain through which boundary node by referring to the route calculation domain information 210.

The reachability information 211 manages reachability information to all route decision systems, and to a node. The reachability information includes boundary node information from a route calculation domain to another route calculation domain, and a route cost to reach such domain. It is possible to figure out that, for example, whether or not it is possible to reach an end node 102 in the domain DM2 through a route including the boundary node BN1 in FIG. 1, and a cost when reaching the end node 102 by referring to the reachability information 211. The route calculation domain information 210 and the reachability information 211 can be acquired by analyzing the reachability information collected by the topology information collecting unit 201.

The route calculation request responding unit 203 is a communication interface with the request originator 106 and another route decision system 100, and transmits/receives a request for a route calculation and the response thereof. The PSS selecting unit 204 has a function of selecting a following route decision system which is used for a route calculation to a domain to which the end node 102 (FIG. 1) belongs by referring to the route calculation domain information 210 and the reachability information 211 both managed by the route calculation domain management unit 202. The interval path abstracting unit 205 has a function of abstracting a plurality of route candidates which have been calculated by another route decision system, and of registering those abstracted route candidates in topology information. More specifically, the interval path abstracting unit 205 has a function of converting a redundant path route calculated by another route decision system 100 into a virtual link with restricting conditions which reflect a cost, and a function of creating a virtual end node based on the restricting conditions. The route calculating unit 206 performs a route calculation in consideration of restrictions.

When receiving a route calculation request from another route decision system 100 or from the request originator 106 through the route calculation request responding unit 203, each of the route decision systems 100 determines whether or not an end node specified by the calculation request is present in a local domain to which each of the route decision systems 100 belongs. When the end node is not present, the PSS selecting unit is caused to select a route decision system which is to issue the route calculation request, and a process (PSS selection process) of issuing the route calculation request to that route decision system is executed. When the end node is present in the local domain to which the route decision system 100 belongs, the route calculating unit 206 is caused to perform the route calculation, and a process (route calculation process) of returning a route calculation response including route candidates acquired by calculation to the originator which has issued the route calculation request is executed.

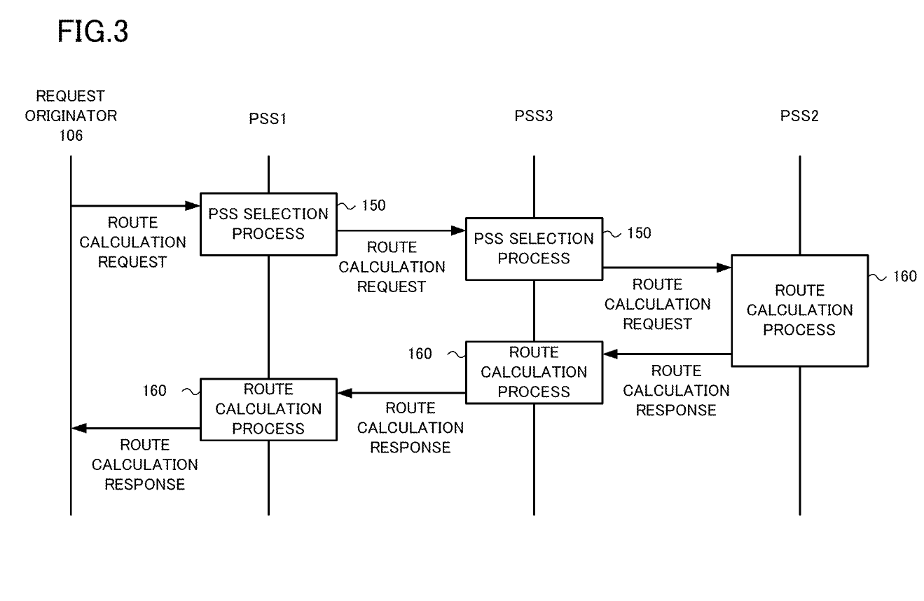

FIG. 3 shows a procedure when performing a route calculation of a redundant path by a plurality of route decision systems. It is assumed that the request originator 106 belonging to the domain DM1 issues a route calculation request from the start node 101 (FIG. 1) in the domain DM1 to the end node 102 in the domain DM2. The request originator 106 issues the route calculation request to the route decision system PSS1. The route decision system PSS1 executes a PSS selection process 150 because the end node 102 is not present in the local domain DM1 to which the route decision system PSS1 belongs. In the PSS selection process 150, the route decision system PSS1 selects, among route calculation domains adjacent to the local domain DM1 to which the route decision system PSS1 belongs, a route decision system which belongs to a route calculation domain adjoining through a boundary node which can reach the end node 102 as an issue destination (transmission destination) of the route calculation request. In the PSS selection process 150, the route decision system PSS1 selects, for example, the route decision system PSS3 belonging to the domain DM3, and issues the route calculation request to the selected route decision system PSS3.

The route decision system PSS3 which has received the route calculation request executes the PSS selection process 150 in the same manner as the route decision system PSS1, and selects, for example, the route decision system PSS2 belonging to the domain DM2. Thereafter, the route decision system PSS3 issues a route calculation request to the selected route decision system PSS2. In this manner, repeating of the PSS selection process 150 in each route decision system 100 allows the route calculation request to be finally transmitted to the route decision system PSS2 belonging to the route calculation domain DM2 where the end node 102 is present. Route calculation domains through which the redundant pass passes from the start node 101 to the end node 102 are settled by the foregoing processes. After the domains to be passed through are settled, a process of performing a route calculation is transitioned from the route calculation domain DM2 side in which the end node 102 is present.

The route decision system PSS2 executes a route calculation process 160 at first because the end node 102 is present in the local domain DM2 to which the route decision system PSS2 belongs. The route decision system PSS2 transmits a route calculation response including route candidates acquired by the route calculation process 160 to the route decision system PSS3. This route calculation response includes the route candidates of the redundant path which are route calculation results calculated by the route decision system PSS2. When receiving the route calculation response from the route decision system PSS2, the route decision system PSS3 executes the route calculation process 160. In the route calculation process 160 which is executed by the route decision system PSS3, first, the interval path abstracting unit 205 is caused to abstract the route candidates of the redundant path which are included in the route calculation response, and add a topology of the abstracted route candidates to topology information in the domain DM3. Next, the route calculating unit 206 is caused to calculate route candidates of the redundant path in the domain DM3 using the topology information to which the abstracted route candidates are added. Thereafter, the route calculation request responding unit 203 is caused to issue a route calculation response that calculated route candidates are added to the route candidates included in the received route calculation response to the route decision system PSS1.

When receiving the route calculation response from the route decision system PSS3, the route decision system PSS1 executes the route calculation process 160 in the same manner as the route decision system PSS3. Thereafter, the route decision system PSS1 issues a route calculation response that locally-calculated route candidates are added to the route candidates included in the received route calculation response to the request originator 106. In this manner, by repeating the route calculation process 160 by each route decision system 100 and by adding routes acquired by calculations, the route calculation response including calculation results of the redundant path from the start node 101 to the end node 102 is finally transmitted to the request originator 106.

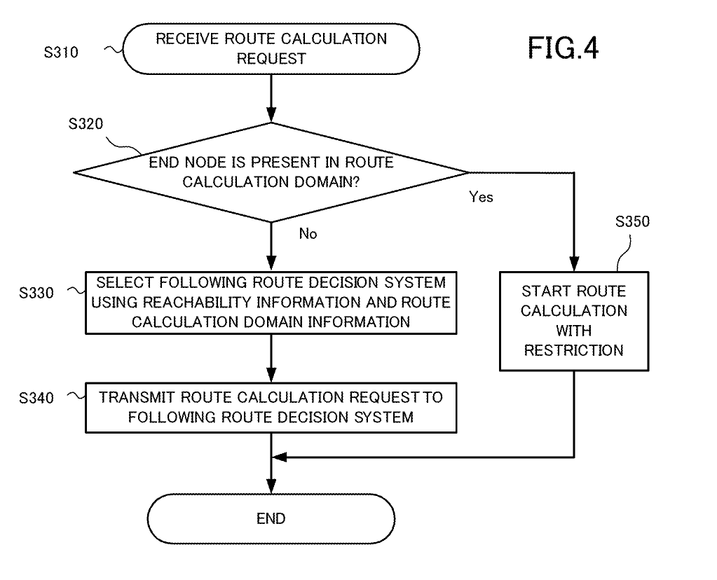

FIG. 4 shows a procedure of the route-decision-system selection process (PSS selection process) 150. When receiving a route calculation request (step S310), the route calculation request responding unit 203 checks whether or not an end node is present in a local route calculation domain to which the route calculation request responding unit 203 belongs (step S320). When the end node is present, the route calculation request responding unit 203 instructs the route calculating unit 206 to start a route calculation with restrictions (step S350). When the end node is not present, the route calculation request responding unit 203 requests the PSS selecting unit 204 to select a route decision system to which a following calculation is requested, in other words, the route decision system 100 of the transmission destination of the route calculation request. The PSS selecting unit 204 receiving this request selects the route decision system of the transmission destination of the route calculation request with the route calculation domain information 210 and the reachability information 211 (step S330). Thereafter, the route calculation request responding unit 203 transmits the route calculation request to the route decision system selected in the step S330 (step S340).

An explanation will be given of, as a selecting technique of the route decision system 100 in the step S330, a technique of comparing reachability information to the end node 102 with reachability information to the route decision system 100 in detail. This technique is called a gateway mapping. A gateway indicates a boundary node which is connected to another route calculation domain. Examples of the kind of reachability information are reachability information as a transfer route in an IP network, and reachability information in a multi-layer network formulated by an ITU-T ASON, and those are notified by a routing protocol, such as the OSPF, the IS-IS, or the BGP.

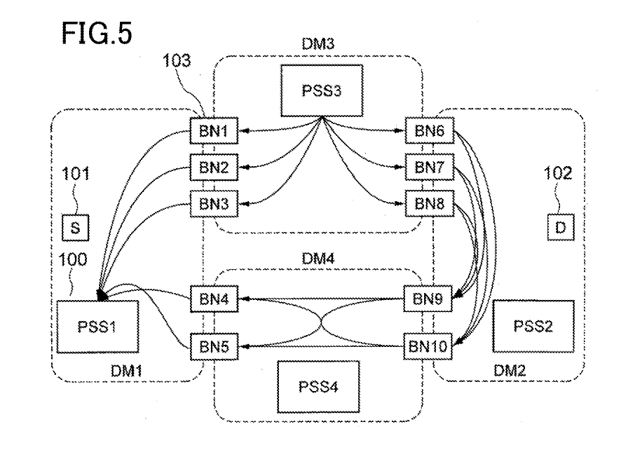

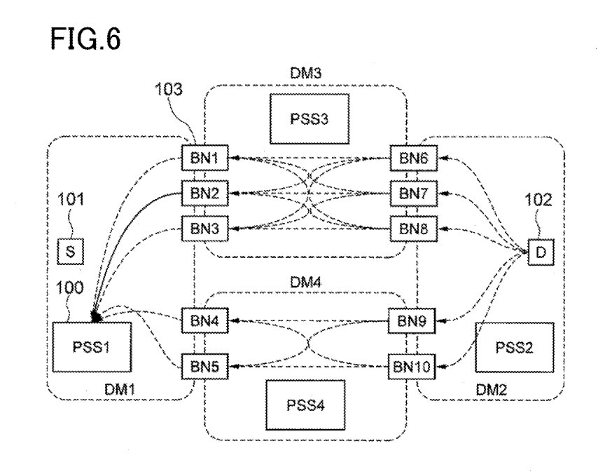

FIG. 5 shows an example route where reachability information on the route decision system PSS3 is notified. Arrows indicate the flow of the reachability information on the route decision system PSS3. Moreover, FIG. 6 shows an example route where reachability information on an end node is notified. Likewise, arrows indicate the flow of the reachability information in the same manner. The reachability information on the route decision system PSS3 goes across from the domain DM3 to the domain DM1, and reaches the route decision system PSS1 in the domain DM1. The reachability information on the route decision system PSS3 further goes across from the domain DM3 to domain DM1 through the domain DM2 and the domain DM4, and reaches the route decision system PSS1. Reachability information on the end node 102 goes across from the domain DM2 to the domain DM1 through the domain DM3 or the domain DM4, and is notified to the route decision system PSS1.

The route decision system PSS1 can figure out through which boundary domain BN reaching information from the route decision system PSS3 and the like comes into the domain DM1 by referring to the reaching information notified through routes shown in FIG. 5 and FIG. 6. Moreover, the reaching information includes information on route costs from departing the route decision system PSS3 to reaching the route decision system PSS1, so that the route decision system PSS1 can figure out which boundary node can reach the route decision system PSS3 with how much cost by analyzing the reaching information.

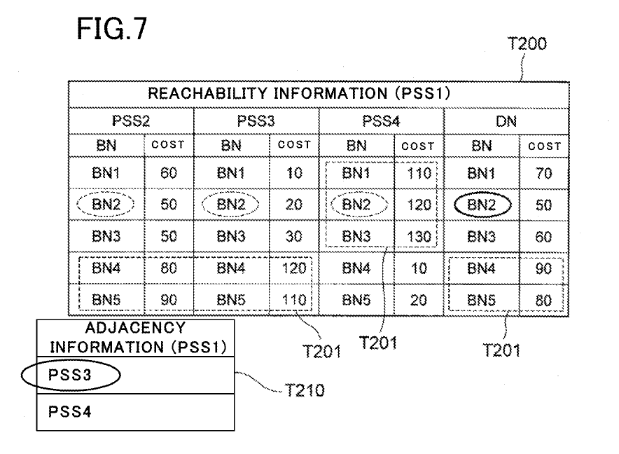

FIG. 7 shows a specific example of reachability information acquired by analyzing the reachability information reaching through the routes shown in FIG. 5 and FIG. 6. The reachability information notified to each route decision system 100 is stored in the form of a table T200 shown in FIG. 7 to all route decision systems and nodes. Contents of this table T200 correspond to the reachability information 211 in FIG. 2. Moreover, a table T210 shown in FIG. 7 corresponds to the route calculation domain information 210 in FIG. 2. Note that, in the table T210, a correspondence between a boundary node and an adjoining route calculation domain is omitted.

When receiving a route calculation request, the route decision system PSS1 selects a boundary node (BN2) which can reach an end node with the minimum cost by referring to the table T200 shown in FIG. 7 based on an end node identifier included in the route calculation request. Next, the route decision system 100 having that boundary node BN2 as a boundary node candidate is searched, and the route decision system PSS2, the route decision system PSS3, and the route decision system PSS4 are acquired. Thereafter, the acquired candidates of the route decision system 100 are narrowed down to only adjoining route decision systems with adjacency information (table T210 in FIG. 7). The route decision system PSS3 and the route decision system PSS4 remain through narrowing down. Thereafter, costs of remaining route decision systems are compared with each other, and the route decision system PSS3 with the minimum cost is finally selected. In this manner, it is possible to select an adjoining route decision system with the optimal cost using reachability information on a route decision system and that on an end node.

Note that, in FIG. 7, information surrounded by a rectangular dashed line (uncertain information T201) is uncertain information with possibilities of not being notified depending on routing protocols. That is, it is information that whether to be notified or not to be notified is unclear. The explanation has been given of a case in which those pieces of uncertain information are notified. When there is no uncertain information, i.e., when reachability information is not notified, the field becomes empty, and is just excluded from selections in the selection process by the PSS selecting unit 204, so that it does not affect the operation. Moreover, even if those pieces of uncertain information are notified, as a result of cost comparison, such pieces of information are not selected in the selection process by the PSS selecting unit 204 because there is a combination of a route decision system with a boundary node which reaches at a lower cost.

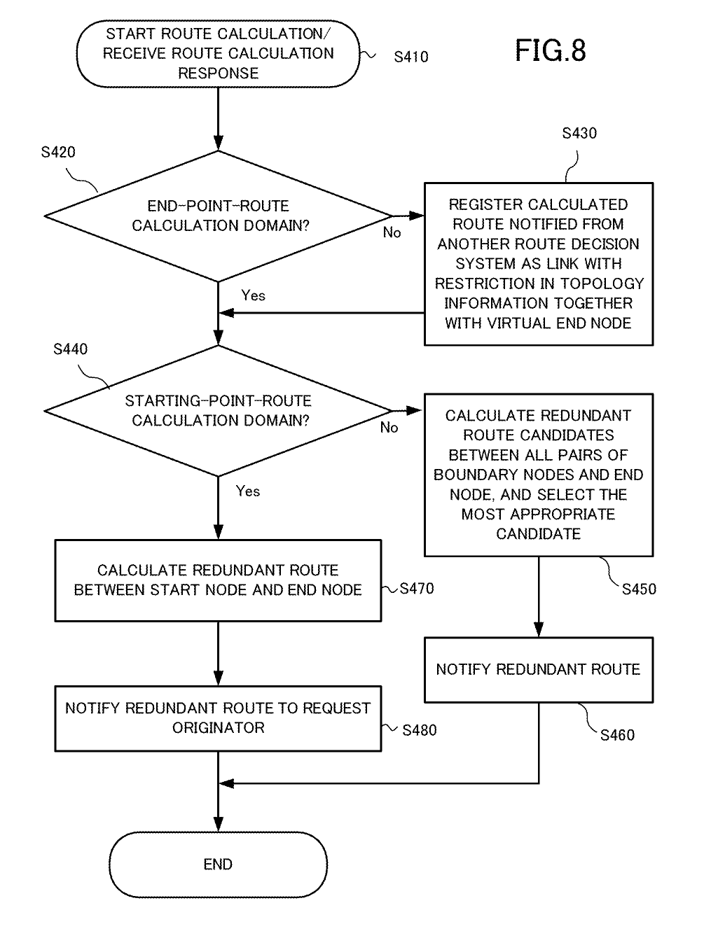

FIG. 8 shows a procedure of the route calculation process 160. Among route calculation domains selected in the PSS selection process 150, the route calculation domain DM1 to which a start node belongs is called a starting-point-route calculation domain, the route calculation domain DM2 to which an end node belongs is called an end-point-route calculation domain, and other route calculation domains DM3 and DM4 are both called intermediate-route calculation domains. The route decision system PSS2 belonging to the end-point-route calculation domain DM2 starts the route calculation process 160 with the start of the route calculation with restrictions in the step S350 in FIG. 4 being as a trigger, and the route decision system 100 belonging to the intermediate-route calculation domain or the starting-point-route calculation domain starts the route calculation process 160 with the reception of a route calculation response which is a response to the route calculation request being as a trigger (step S410).

At the start of the route calculation process, the route decision system 100 determines whether or not a local domain to which the route decision system 100 belongs is the end-point-route calculation domain, and whether or not the local domain to which the route decision system 100 belongs is the starting point domain (step S420, step S440). When the local domain to which the route decision system 100 belongs is the end-point-route calculation domain, the route calculating unit 206 is caused to perform route calculation to calculate route candidates of a redundant path in the end-point-route calculation domain (step S450). In this process, the route calculating unit 206 calculates candidates of the redundant path from all pairs of boundary nodes connected to the intermediate-route calculation domain to the end node by referring to the topology information 212 and to the route calculation domain information 210. Thereafter, the route calculation request responding unit 203 is caused to issue a route calculation response including calculation results to a route decision system of an originator which has issued the route calculation request (step S460).

When the local domain to which the route decision system 100 belongs is not the end point domain, that is, when the local domain to which the route decision system 100 belongs is the intermediate-route calculation domain or the starting-point-route calculation domain, the route decision system 100 causes the interval path abstracting unit 205 to register route candidates included in the route calculation response as links with restrictions together with a virtual end node in topology information (step S430). Thereafter, when the local domain to which the route decision system 100 belongs is the intermediate-route calculation domain, the process transitions from the step S440 to the step S450, candidates of a redundant route from all pairs of boundary nodes connected to the starting-point-route calculation domain or to the intermediate-route calculation domain to the virtual end node are calculated, and a route calculation response including those route calculation results is issued to the route decision system 100 which belongs to the starting-point-route calculation domain or another intermediate-route calculation domain in the step S460. When the local domain to which the route decision system 100 belongs is the starting-point-route calculation domain, the route decision system 100 causes the route calculating unit 206 to calculate the redundant route from the start node to the virtual end node (step S470), and issues a route calculation response including that calculation result to the request originator 106 (step S480).

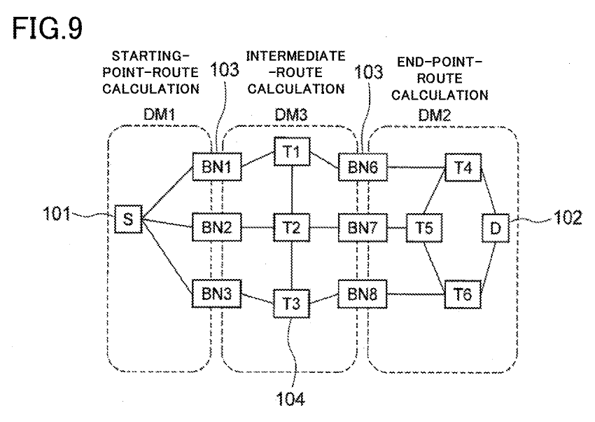

An explanation will be given of an example of the foregoing route calculation. FIG. 9 shows an example topology of a multi-domain network. FIG. 9 shows a sequence of route calculation domains after the route calculation domains are set by the PSS selection process 150, and the domain DM1 configures a starting-point-route calculation domain, the domain DM3 configures an intermediate-route calculation domain, and the domain DM2 configures an end-point-route calculation domain. In FIG. 9, the start node 101 is denoted by S, the end node 102 is denoted by D, the boundary nodes 103 positioned in a boundary of the route calculation domains are denoted by BN1 to BN3, BN6 to BN8, and other nodes (intermediate nodes 104) are denoted by T1 to T6. Note that, in a link connecting each node, a cost used for a route calculation is uniformly set to 10. Moreover, although it is not illustrated in FIG. 9, a route decision system is arranged in each route calculation domain one by one.

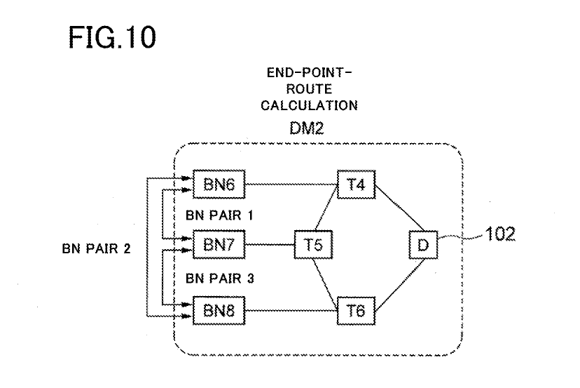

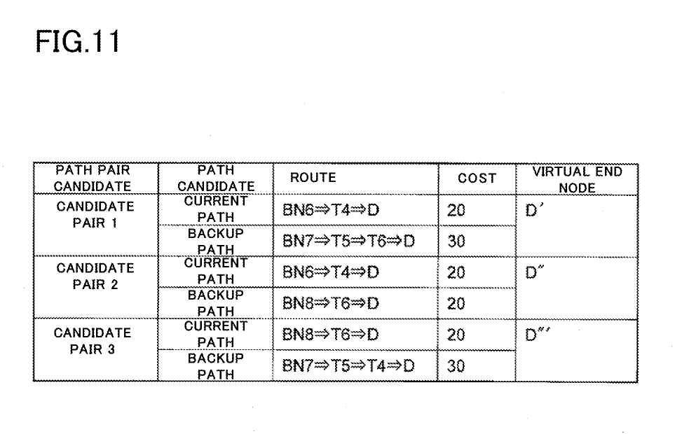

An explanation will be given of a procedure of calculating the route of a redundant path from the node S to the node D in a sample topology shown in FIG. 9. A route calculation request issued by a request originator reaches the route decision system PSS2 belonging to the end-point-route calculation domain DM2 from the starting-point-route calculation domain DM1 through the intermediate-route calculation domain DM3. First, an explanation will be given of a route calculation in the end-point-route calculation domain DM2. FIG. 10 and FIG. 11 show a topology which is used for calculations in the end-point-route calculation domain DM2 and calculated candidates of the redundant path, respectively. The route decision system 100 of the end-point-route calculation domain DM2 calculates redundant paths that the routes thereof do not overlap between all boundary node pairs which are between the intermediate-route calculation domain DM3 and the end-point-route calculation domain DM2 and the end node.

An efficient algorithm to calculate the redundant paths that the routes thereof from each boundary node pair to the end node D do not overlap is shown below. First, in the topology shown in FIG. 10, the shortest path from the end node D to the boundary node BN6 is calculated using Dijkstra's algorithm, and in the topology that a link used by the acquired shortest path is deleted from topology information, paths of the shortest tree from the end node D to the boundary nodes BN7 and BN8 are calculated using Dijkstra's algorithm in the same manner. Next, in the topology shown in FIG. 10, in the topology that a link used by the shortest path acquired by calculating the shortest path from the end node D to the boundary node BN7 using Dijkstra's algorithm is deleted from the topology information, a path of the shortest tree from D to BN8 is calculated using Dijkstra's algorithm in the same manner. Below is a summary of those routes.

Candidates of the redundant path when BN6 is paired with BN7 (pair 1):

redundant routes to D; D to T4 to BN6: 20 costs, D to T6 to T5 to BN7: 30 costs

candidates of the redundant path when BN6 is paired with BN8 (pair 2):

redundant routes to D; D to T4 to BN6: 20 costs, D to T6 to BN8: 20 costs, and

candidates of the redundant path when BN7 is paired with BN8 (pair 3):

redundant routes to D; D to T6 to BN8: 20 costs, D to T4 to T5 to BN7: 30 costs.

Candidate pairs of the redundant path shown in a table T220 in FIG. 11 are made through the foregoing calculations. Those pairs are notified to the route decision system 100 belonging to the intermediate-route calculation domain DM3. In this manner, using the shortest tree calculations from the end node to the boundary nodes, it is possible to calculate the routes of redundant path pairs to all boundary node pairs by trial of Dijkstra's algorithm which are less than route calculations of the redundant path to each of the boundary node pairs. FIG. 11 shows virtual end nodes D′, D″, and D′″ corresponding to the boundary node pairs in respective redundant paths.

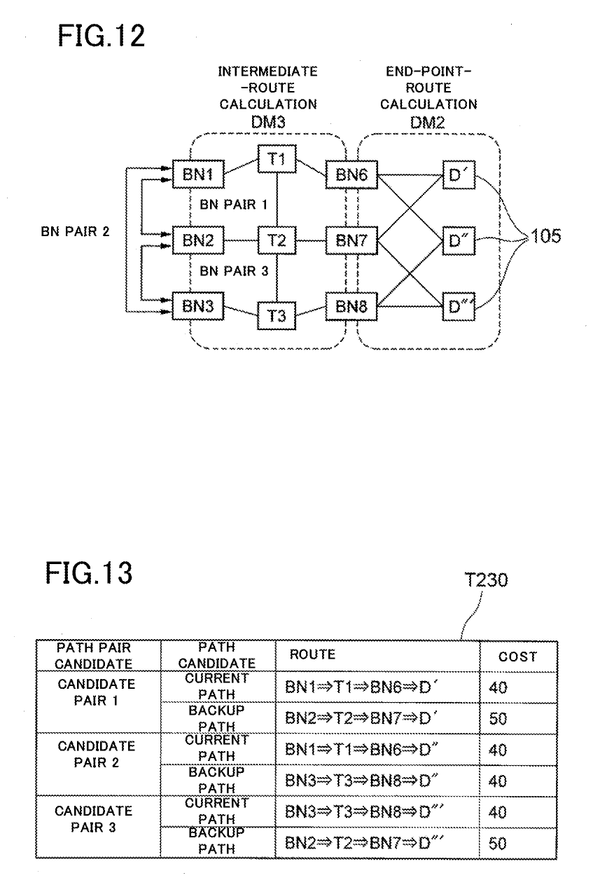

Next, an explanation will be given of route calculations in the intermediate-route calculation domain DM3. FIG. 12 and FIG. 13 show a topology which is used for calculations in the intermediate-route calculation domain DM3 and calculated candidates of the redundant path, respectively. The route decision system PSS3 of the intermediate-route calculation domain DM3 performs route calculations using a topology that routes of the redundant path calculated in the end-point-route calculation domain DM2 are added as links with restrictions per the virtual end node 105 to the topology of the intermediate-route calculation domain DM3. Creating the links with restrictions per the virtual end node 105 is to maintain restricting information that the routes of the redundant path calculated in the end-point-route calculation domain DM2 do not share a network resource one another, and each of path candidate pairs 1, 2, 3 in the end-point-route calculation domain DM2 corresponds to the link with restrictions to D′, D″, or D′″ which is the virtual end node 105.

The route decision system PSS4 of the intermediate-route calculation domain DM3 calculates redundant paths with routes which do not overlap between all boundary node pairs which are in between the starting-point-route calculation domain DM1 and the intermediate-route calculation domain DM3 and all virtual end nodes 105. An algorithm to calculate redundant paths with the routes which do not overlap from each boundary node pair to each virtual end node 105 is the same algorithm as that of the redundant path calculation in the end-point-route calculation domain DM2. That is, first, in a topology shown in FIG. 12, the shortest paths from D, D′, and D′″ to BN1 are calculated, respectively, using Dijkstra's algorithm, and in the topology that links used by the shortest paths acquired respectively are deleted from topology information, and paths of the shortest tree from D′, D″, and D′″ to BN2 and BN3 are calculated, respectively, using Dijkstra's algorithm in the same manner. Next, in the topology shown in FIG. 12, the shortest paths from D′, D″, and D′″ to BN2, respectively, are calculated using Dijkstra's algorithm, and in the topology that links used by the shortest paths acquired respectively are deleted from the topology information, paths of the shortest tree from D′, D″, and D′″ to BN3 are calculated, respectively, using Dijkstra's algorithm in the same manner.

Below is a summary of the routes acquired through the foregoing calculations.

Candidates of the redundant path when BN1 is paired with BN2:

redundant routes to D′; D′ to BN6 to T1 to BN1: 40 costs, D′ to BN7 to T2 to BN2: 50 costs

redundant routes to D″; D″ to BN6 to T1 to BN1: 40 costs, D″ to BN8 to T3 to T2 to BN2: 50 costs

redundant routes to D′″; D′″ to BN7 to T2 to T1 to BN1: 60 costs, no redundant route

candidates of the redundant path when BN1 is paired with BN3:

redundant routes to D′; D′ to BN6 to T1 to BN1: 40 costs, D′ to BN7 to T2 to T3 to BN3: 60 costs

redundant routes to D″; D″ to BN6 to T1 to BN1: 40 costs, D″ to BN8 to T3 to BN3: 40 costs

redundant routes to D′″; D′″ to BN7 to T2 to T1 to BN1: 60 costs, D′″ to BN8 to T3 to BN3: 40 costs

candidates of the redundant path when BN2 is paired with BN3:

redundant routes to D′; D′ to BN7 to T2 to BN2: 50 costs, no redundant route

redundant routes to D″; D″ to BN6 to T1 to T2 to BN2: 50 costs, D″ to BN8 to T3 to BN3: 40 costs, and

redundant routes to D′″; D′″ to BN8 to T3 to BN3: 40 costs, D′″ to BN7 to T2 to BN2: 50 costs.

The virtual end nodes D′, D″, and D′″ indicate the same end node, so that the most appropriate route to the boundary node pairs can be selected by cost comparison. Note that, as the criterion for selecting a path, although a redundant path candidate that the sum of the costs of the redundant paths is the minimum, a redundant path candidate having the route with the minimum cost, or the like is considered, it is assumed that the redundant path candidate that the sum of the costs thereof is the minimum is selected. Moreover, when there are a plurality of redundant path candidates that the sums of the costs thereof are the minimum, although it is possible to select all of the plurality of redundant path candidates as paths having equal costs, it is assumed that a single redundant path candidate is selected in this case.

Through the foregoing operation, candidate pairs of the redundant path shown in a table T230 in FIG. 13 are set. In this manner, using the shortest tree calculations from the end node to the boundary nodes, it is possible to calculate the routes of redundant path pairs to all boundary node pairs by trials of Dijkstra's algorithm which are less than route calculations of the redundant path to each of the boundary node pairs.

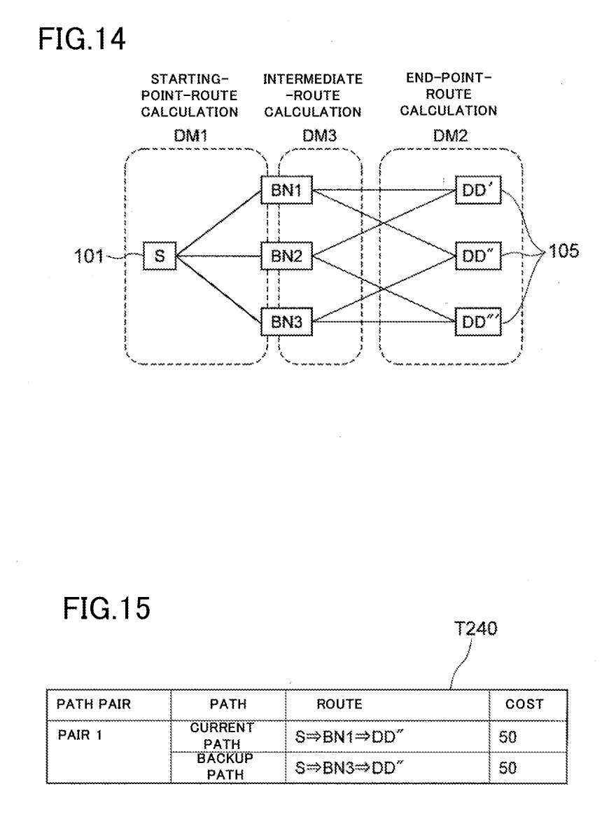

Next, an explanation will be given of route calculations in the starting-point-route calculation domain DM1. FIG. 14 and FIG. 15 show a topology used for calculations in the starting-point-route calculation domain DM1, and a calculated result of the redundant path, respectively. The route decision system PSS1 in the starting-point-route calculation domain DM1 performs route calculations using a topology that the routes of the redundant path calculated in the intermediate-route calculation domain DM3 are added as links with restrictions per the virtual end node 105 to the topology of the starting-point-route calculation domain DM1. Creating the links with restrictions per the virtual end node is to maintain restricting information that the routes of the redundant path calculated in the intermediate-route calculation domain DM3 do not overlap one another, and each of path candidate pairs 1, 2, 3 in the intermediate-route calculation domain DM3 corresponds to the link with restrictions to DD′, DD″, or DD′″.

The route decision system PSS1 in the starting-point-route calculation domain DM1 calculates redundant paths having no routes overlapped between the start node S and all virtual end nodes. First, in the topology shown in FIG. 14, the shortest paths from DD′, DD″, and DD′″ to the node S are calculated, respectively, using Dijkstra's algorithm, and in the topology that links used by the shortest paths acquired respectively are deleted from topology information, paths of the shortest tree from DD′, DD″, and DD′″ to the node S are calculated, respectively, using Dijkstra's algorithm in the same manner. Below is a summary of the routes acquired through the foregoing calculations.

redundant routes to DD′; DD′ to BN1 to S: 50 costs, DD′ to BN2 to S: 60 costs

redundant routes to DD″; DD″ to BN1 to S: 50 costs, DD″ to BN3 to S: 50 costs, and

redundant routes to DD′″; DD′″ to BN2 to S: 60 costs, DD′″ to BN3 to S: 60 costs.

The virtual end nodes DD', DD″, and DD′″ indicate the same end node, so that the most appropriate route from the start node S to the end node N can be selected based on the costs. Note that, as the criteria for selecting a path, although a redundant path candidate that the sum of the costs of the redundant paths is the minimum, a redundant path candidate having the route with the minimum cost, or the like is considered, it is assumed that the redundant path candidate that the sum of the costs thereof is the minimum is selected. Moreover, when there are a plurality of redundant path candidates that the sums of the costs thereof are the minimum, although it is possible to select all of a plurality of redundant path candidates as paths having equal costs, it is assumed that a single redundant path candidate is selected in this case. Through the foregoing operation, a redundant path shown in a table T240 in FIG. 15 is set as the most appropriate path, and a route calculation result across multi domains can be acquired.

According to the embodiment, the route of the redundant path between the start node and the end node is calculated by setting a route calculation domain to be passed through from a route calculation domain where a start node is present to a route calculation domain where an end node is present, by causing the route calculating unit 206 to sequentially perform the route calculation of a redundant path by each route decision system 100 from the route calculation domain side where the end node is present to the route calculation domain where the start node is present, and by combining routes of the redundant path calculated by respective route decision systems together. A calculation result by a route decision system at the route calculation domain side where the end node is present is included in a calculation response and notified to a route decision system at the route calculation domain side where the start node is present or to an originator which has issued a request. In this manner, in a multi-domain network divided into a plurality of route calculation domains, it is possible to calculate the redundant path as a plurality of route decision systems work together so as not to share a network resource without starting over trial and error in a route calculation in each route calculation domain.

Moreover, according to the embodiment, in the selection of a route decision system (route calculation domain) of the transmission destination of a route calculation request by the PSS selecting unit 204, among route calculation domains adjacent to a local domain to which a route decision system belongs, a route calculation domain adjoining through a boundary node which can reach an end node is selected as a route calculation domain to which the route calculation request is to be transmitted. This allows a route calculation domain with a reachability to the end node to be selected, so that it is possible to suppress any starting over of selecting a route calculation domain caused by selecting a route calculation domain which does not reach the end node. Moreover, in the selection of a route calculation domain, it is possible to maintain the cost of a redundant path low by selecting a route calculation domain which reaches an end point domain with the minimum cost.

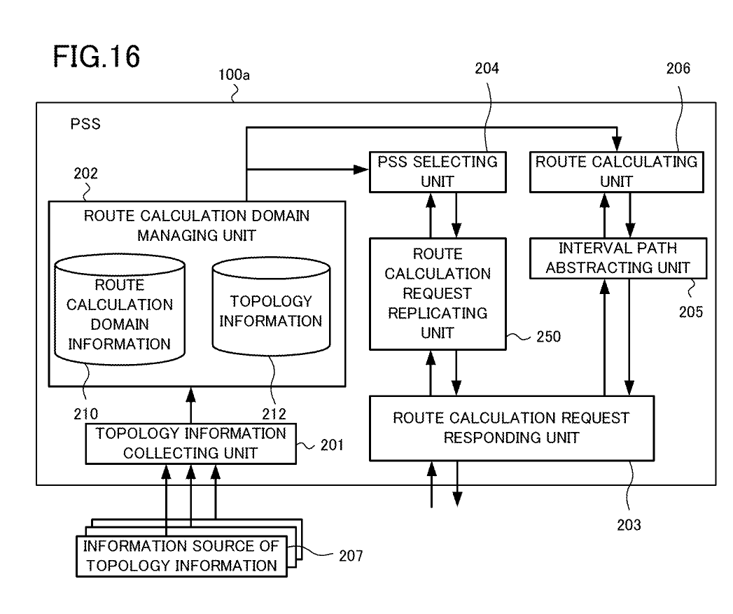

Next, an explanation will be given of a second embodiment of the present invention. FIG. 16 shows the configuration of a route decision system according to the second embodiment. A route decision system 100a includes the topology information collecting unit 201, the route calculation domain managing unit 202, the route calculation request responding unit 203, the PSS selecting unit 204, a route calculation request replicating unit 250, the interval path abstracting unit 205, and the route calculating unit 206. The route decision system 100a is configured by a computer system, and the function of each unit in the route decision system 100a is realized by running a program installed in the computer system. A difference from the first embodiment is that the route calculation request replicating unit 250 which replicates a received route calculation request into equal to or more than two route calculation requests is added, and the reachability information 211 in the route calculation domain managing unit 202 is omitted. The network configuration in the second embodiment is the same as the network configuration shown in FIG. 1.

According to the second embodiment, the PSS selecting unit 204 selects a route decision system belonging to a route calculation domain adjoining the PSS selecting unit 204 as a route decision system to which a route calculation request is to be transmitted by referring to the route calculation domain information 210. When there are a plurality of route decision systems to be selected by the PSS selecting unit 204, the route calculation request replicating unit 205 replicates the route calculation request by what corresponds to a required number, and transmits the route calculation requests to respective route decision systems selected by the PSS selecting unit 204. Replication and transmission of the route calculation request are repeated until the route calculation request reaches the route decision system PSS2 belonging to the route calculation domain DM2 where the end node 102 is present. Thereafter, the route of a redundant path is set by sequentially performing the route calculations on respective route calculation requests which have reached the route decision system PSS2 belonging to the end-point-route calculation domain DM2 from the end-point-route calculation domain DM2 side, and by comparing costs in the route decision system PSS1 belonging to the starting-point-route calculation domain 101.

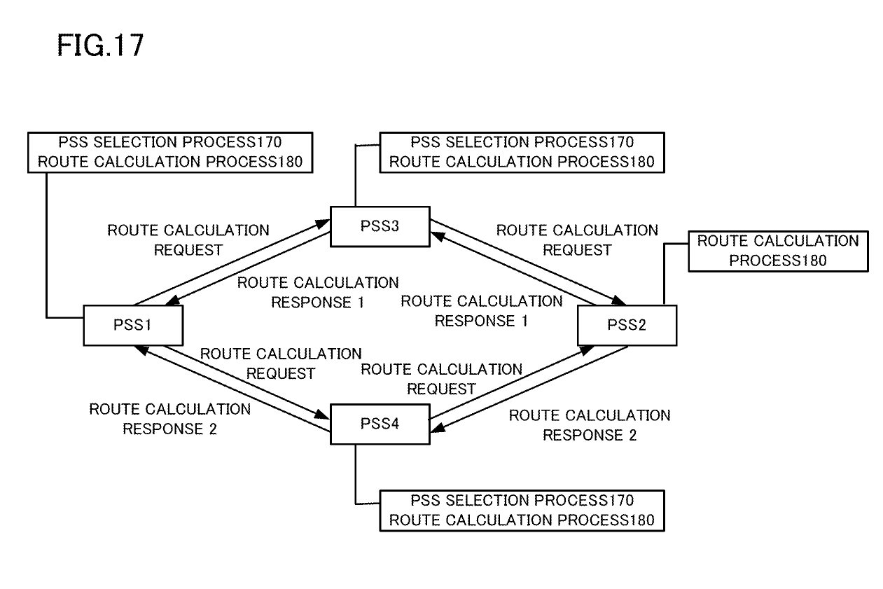

FIG. 17 shows a procedure when performing the route calculation of a redundant path by a plurality of route decision systems 100a in the second embodiment. When the request originator 106 (FIG. 1) of the route calculation issues a route calculation request, the route decision system PSS1 executes a route-decision-system selection process 170, and sets the domain DM3 and the domain DM4 adjoining the local domain DM1 to which the route decision system PSS1 belongs as the transmission destination of the route calculation request. The route decision system PSS1 causes the route calculation request replicating unit 205 to replicate the route calculation request, and transfers the route calculation requests to both the route decision system PSS3 and the route decision system PSS4.

The route decision system PSS3 and the route decision system PSS4 which has received the route calculation requests execute the route-decision-system selection processes 170 in the same manner as the route decision system PSS1, set the domain DM2 adjoining the route decision system PSS3 and the route decision system PSS4, respectively, as the transmission destination of the route calculation requests, and transfer the route calculation requests to the route decision system PSS2. In this manner, repeating of the PSS selection process in each route decision system 100a allows the route calculation request issued by the request originator to reach the route decision system PSS2 belonging to the domain DM2 where the end node 102 is present.

In FIG. 17, the route calculation requests reach the route decision system PSS2 through two routes: one which reaches the domain DM2 from the domain DM1 through the domain DM3; and another which reaches the domain DM2 from the domain DM1 through the domain DM4. The route decision system PSS2 executes a route calculation process 180 on each of the received route calculation requests, and issues a route calculation response including a route calculation result to the route decision system of the transmission originator of the route calculation request. That is, a route calculation response (response 1) including a route calculation result to the route calculation request received from the route decision system PSS3 is issued to the route decision system PSS3, and a route calculation response (response 2) including a route calculation result to the route calculation request received from the route decision system PSS4 is issued to the route decision system PSS4.

The route decision system PSS3 and the route decision system PSS4 which have received the route calculation responses, respectively, execute the route calculation processes 180, respectively, add locally-calculated results to the calculation results which are included in the received route calculation responses, and issue route calculation responses to the route decision system PSS1. When receiving the route calculation responses from the route decision system PSS3 and the route decision system PSS4, respectively, the route decision system PSS1 executes the route calculation process 180 on each of the route calculation responses. Thereafter, a calculation result of the redundant path calculated with the route calculation response 1 received from the route decision system PSS3 and a calculation result of the redundant path calculated with the route calculation response 2 received from the route decision system PSS4 are compared with each other, either of the calculation results is selected, and a route calculation response including the selected calculation result is issued to the request originator 106.

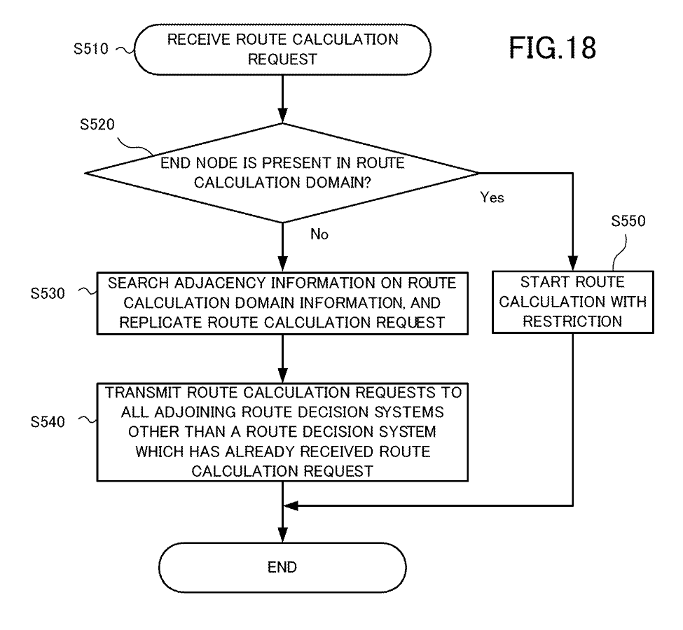

FIG. 18 shows a procedure of the PSS selection process 170. When the route calculation request responding unit 203 receives a route calculation request (step S510), the route decision system 100a determines whether or not the end node 102 is present in a local route calculation domain to which the route decision system 100a belongs (step S520). When the end node 102 is present, the route calculating unit 206 is caused to start a route calculation with restrictions (step S550). When the end node 102 is not present, the route decision system 100a searches a route decision system to which the route calculation request is to be transmitted, i.e., a route decision system belonging to a route calculation domain adjoining the local route calculation domain to which the route decision system 100a belongs using the adjacency information of the route calculation domain information 210 (T210 in FIG. 7) (step S530). When there are a plurality of route decision systems 100a to which the route calculation request is to be transmitted, the route calculation request replicating unit 250 is caused to replicate the route calculation request by what corresponds to a required number, and the route calculation requests are transmitted to the respective route decision systems searched in the step S530 (step S540).

Note that, when the route decision system 100a is searched in the step S530, among all the route decision systems 100a belonging to the adjoining route calculation domains, the route decision system 100a other than a route decision system which has received the route calculation request already through an overlapped route is selected. For example, in FIG. 17, although the route decision system PSS1 transmits the route calculation requests to the route decision system PSS3 and the route decision system PSS4, respectively, the route decision system PSS3 and the route decision system PSS4 do not transmit a route calculation request to the route decision system PSS1 which is an originator that is to receive the route calculation requests. Moreover, in searching of a route decision system, when there is no corresponding route decision system, it is assumed that the route calculation request is discarded.

The route calculation process 180 executed in each route decision system is same as the route calculation process 160 executed in the procedure shown in FIG. 8 in the first embodiment. Note that, in the second embodiment, there is a case in which route calculation requests reach the route decision system PSS2 belonging to the end-point-route calculation domain DM2 through a plurality of routes, and in this case, a plurality of route calculation responses reach the route decision system PSS1 belonging to the starting-point-route calculation domain DM1. When receiving the plurality of route calculation responses, the route decision system PSS1 performs route calculations on those respective responses, selects a route with the minimum cost from those responses, and then transmits the selected route to the request originator 106.

When route calculation results to the plurality of route calculation responses are compared with each other by the route decision system PSS1 belonging to the starting-point-route calculation domain DM1, it is necessary to wait until all of the plurality of route calculation responses are received. In order to wait, the route decision system PSS1 belonging to the starting-point-route calculation domain DM1 needs to figure out how many route calculation requests have reached the route decision system PSS2 belonging to the end-point-route calculation domain DM2. Accordingly, a route calculation response issued by the route decision system PSS2 belonging to the end-point-route calculation domain DM2 includes a total number of route calculation requests which have reached the end-point-route calculation domain DM2. This allows the route decision system PSS1 belonging to the starting-point-route calculation domain DM1 to figure out the total number of route calculation responses to be received.

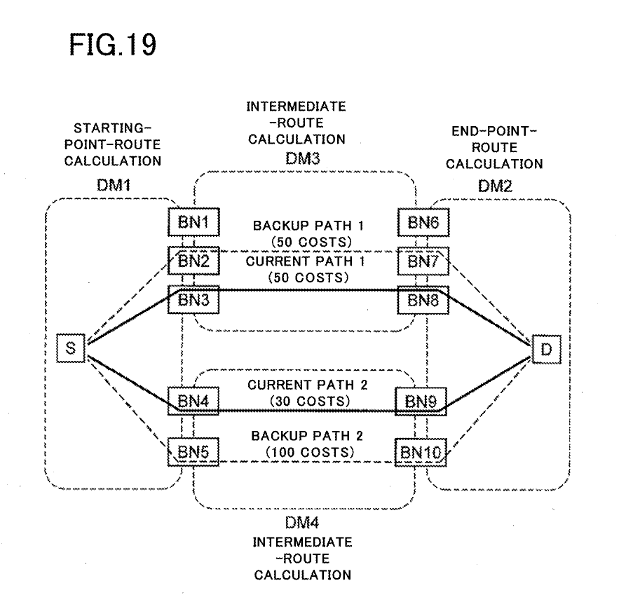

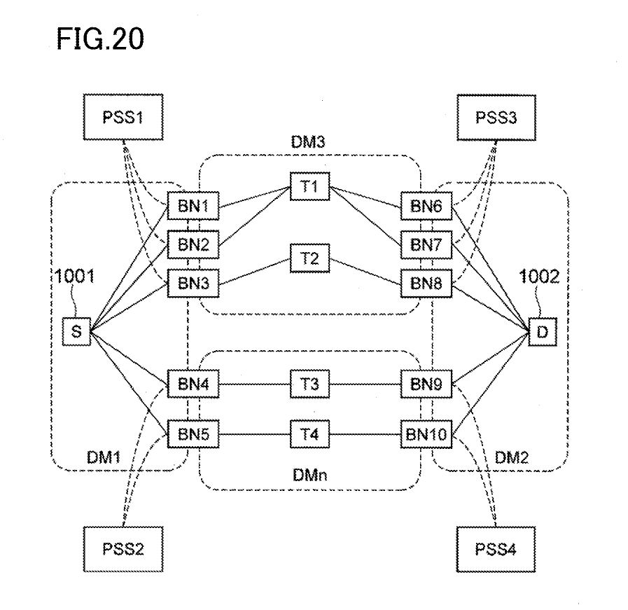

FIG. 19 shows the route calculation result of the redundant path. When route calculations are performed in the route decision system PSS1 belonging to the starting-point-route calculation domain DM1 based on the route calculation response to the route calculation request transmitted through a route which reaches the domain DM2 from the domain DM1 through the domain DM3, redundant paths, such as:

a current path 1: S to BN3 to BN8 to D (50 costs); and

a backup path 1: S to BN2 to BN7 to D (50 costs)

are acquired. Moreover, when route calculations are performed in the route decision system PSS1 based on the route calculation response to the route calculation request transmitted through a route which reaches the domain DM2 from the domain DM1 through the domain DM4, redundant paths, such as:

a current path 2: S to BN4 to BN9 to D (30 costs); and

a backup path 2: S to BN5 to BN10 to D (100 costs)

are acquired. In this manner, according to the second embodiment, a plurality of pairs of plural current paths and plural backup paths are acquired.

In selection of a path from the plurality of pairs of the current paths and the backup paths, a pair that the sum of the cost of a current path and that of the backup path becomes the minimum can be selected as the current path and the backup path. In FIG. 19, the sum of the cost of the current path 1 and that of the backup path 1 is 100, and the sum of the cost of the current path 2 and that of the backup path 2 is 130, so that the pair of the current path 1 and the backup path 1 is selected as the current path and the backup path. Alternatively, as substitute for this pair, a pair that the cost of a current path becomes the minimum can be selected as the current path and the backup path. In FIG. 19, the cost of the current path 1 is 50, and the cost of the current path 2 is 30, so that the pair of the current path 2 and the backup path 2 is selected as the current path and the backup path. Moreover, an arbitrary pair that the costs thereof become the minimum can be selected as the current path and the backup path. In FIG. 19, two paths are selected in an ascending order of cost, and a pair of the current path 2 which has 30 costs and the current path 1 which has 50 costs is selected as the current path and the backup path.

According to the second embodiment, the route decision system PSS1 transmits route calculation requests to the route decision systems PSS3 and PSS4, respectively, which belong to the respective route calculation domains DM3 and DM4 both adjoining the local route calculation domain DM1 to which the route decision system PSS1 belongs, and finally performs route calculations sequentially on respective route calculation requests which have reached the route decision system PSS2 belonging to the route calculation domain DM2 where the end node 102 is present from the end-point-route calculation domain DM2 side. This allows route calculation domains used for route calculations to be set through a route with a reachability from the starting-point-route calculation domain DM1 to the end-point-route calculation domain DM2, and redundant paths which do not share a network resource in a multi-domain network divided into a plurality of route calculation domains can be calculated without repeating trial and error in a route calculation in each route calculation domain. Moreover, employed in the second embodiment is a scheme that a route request is transmitted, among adjoining route calculation domains, to a route decision system belonging to a route calculation domain other than a route calculation domain which has already received the route calculation request, so that a plurality of route calculation domains can be taken as candidates of route calculations, thereby enabling calculation of the most appropriate path in a wider range.

Note that, in each of the foregoing embodiments, although the explanation has been given of an example case in which Dijkstra's algorithm is sequentially used as an algorithm to calculate routes of a redundant path, the present invention is not limited to this case, and other algorithms are also applicable. Moreover, in each of the foregoing embodiments, although the explanation has been given of a case in which the boundary of domains is a node, the present invention is applicable in the same manner to a case in which the boundary is a link.

Although the explanation has been given by referring to the exemplified embodiments which specifically indicate the present invention, the present invention is not limited to those embodiments and modified embodiments thereof. As is apparent to those skilled in the art, the present invention can be changed and modified in various forms without departing from the spirit and the scope of the present invention defined by the appended claims.

This application is based on and claims the benefit of priority from Japanese Patent Application No. 2007-271687, filed on Oct. 18, 2007, the disclosures of which are incorporated herein entirely by reference in the specification of this application.

### INDUSTRIAL APPLICABILITY

The present invention can be used for an application of a route decision system such that the route of a redundant path is set in a multi-domain network where a large-scale communication network is divided into a plurality of domains. Moreover, the present invention can be used not only for the communication networks, but also for an application of the route setting function of a navigation system equipped in vehicles, cellular phones, or the like.

1. A network system comprising:
a plurality of route decision systems which are distributed and arranged in a multi-domain network divided into a plurality of route calculation domains, and wherein
each route decision system comprises a topology information collecting unit which collects topology information, a route calculation request responding unit which receives a route calculation request requesting route calculations of a redundant path from a start node to an end node, and a route calculating unit which performs route calculation in response to the route calculation request using the topology information in consideration of a restriction, and
after a route calculation domain to be passed through from a route calculation domain where the start node is present to a route calculation domain where the end node is present is set, a route of the redundant path between the start node and the end node is calculated by causing the route calculating unit to sequentially perform route calculation of the redundant path in each route decision system from the route calculation domain where the end node is present toward the route calculation domain where the start node is present, and by combining routes of the redundant path calculated by respective route decision systems together.

2. The network system according to claim 1, wherein the route calculation request from an originator which has issued a request is sequentially transmitted from a route decision system belonging to the route calculation domain where the start node is present to a route decision system belonging to the route calculation domain where the end node is present, and a route calculation domain where a route decision system to which the route calculation request has been transmitted belongs is set as a route calculation domain to be used for the route calculation.

3. The network system according to claim 2, wherein when performing route calculation of the redundant path, each of the route decision systems issues a route calculation request including a result of the route calculation of the redundant path to a transmission originator of the route calculation request.

4. The network system according to claim 3, wherein each of the route decision systems further comprises a route calculation domain managing unit which creates adjacency information including information to specify a route calculation domain adjoining a local route calculation domain to which each of the route decision systems belongs based on reachability information from another route decision system and collected by the topology information collecting unit, and a route-decision-system selecting unit which selects a route calculation domain where a route decision system to which the route calculation request received by the route calculation request responding unit is to be transmitted belongs using the adjacency information.

5. The network system according to claim 4, wherein the route calculation domain managing unit analyzes reachability information from the another route decision system and from the end node, and stores, as a reachability information table, a boundary node between the local route calculation domain to which the route calculation domain managing unit belongs and another route calculation domain in association with costs when each boundary node is used from the route calculation domain managing unit to a route decision system belonging to another route calculation domain and to the end node, and the route-decision-system selecting unit selects, as a route decision system to which the route calculation request is to be transmitted, a route calculation domain adjoining through a boundary node which can reach the end node among route calculation domains adjoining a local route calculation domain to which the route-decision-system selecting unit belongs by referring to the reachability information table and the adjacency information.

6. The network system according to claim 5, wherein in selection of the route decision system to which the route calculation request is to be transmitted, a boundary node with a minimum cost is specified among the boundary nodes which can reach the end node, and a route decision system with a minimum cost among route calculation domains adjoining through the specified boundary node is selected as a route decision system to which the route calculation request is to be transmitted.

7. The network system according to claim 4, wherein the route-decision-system selecting unit sets a route calculation domain adjoining the local route calculation domain to which the route-decision-system selecting unit belongs as a transmission destination of the route calculation request, and when there are a plurality of transmission destinations, the route-decision-system selecting unit replicates the route calculation request, and transmits the route calculation requests to respective route decision systems belonging to respective route calculation domains each of which is set as the transmission destination.

8. The network system according to claim 7, wherein when receiving the route calculation responses from the plurality of route decision systems, the route calculating unit of the route decision system belonging to the route calculation domain where the start node is present performs route calculation using the received respective route calculation responses, compares route calculation results, and sets a route to be included in a route calculation response to be transmitted to the start node.

9. The network system according to claim 4, wherein when the route calculation request response receives the route calculation request, the route calculating unit determines whether or not the end node is present in a local route calculation domain to which the route calculating unit belongs, and requests the route-decision-system selecting unit to select a route calculation domain of a transmission destination of the route calculation request when determining that the end node is not present.

10. The network system according to claim 9, wherein when determining that the end node is present in the local route calculation domain to which the route calculating unit belongs, the route calculating unit calculates a route candidate of a redundant path between a boundary node which is between the local route calculation domain to which the route calculating unit belongs and a route calculation domain to which a route calculation system that is a transmission originator of the route calculation request belongs, and the end node using the topology information, and issues a route calculation response including the calculated route candidate of the redundant path to the transmission originator of the route calculation request through the route calculation request responding unit.

11. The network system according to claim 10, wherein when the route calculation request responding unit receives a route calculation result from a route decision system of the route calculation request transmission destination, the route calculating unit determines whether or not the start node is present in the local route calculation domain to which the route calculating unit belongs, and when determining that the start node is not present, calculates a route candidate of a redundant path in the local route calculation domain to which the route calculating unit belongs using such topology information that is obtained by adding a topology having an abstracted route candidate of a redundant path calculated in a route decision system of the route calculation request transmission destination to the aforementioned topology information, and issues a route calculation response including the calculated route candidate of the redundant path to a route decision system of a transmission originator of the route calculation request through the route calculation request responding unit.

12. The network system according to claim 11, wherein when determining that the start node is present in the local route calculation domain to which the route calculating unit belongs, the route calculating unit calculates a route candidate of a redundant path in the local route calculation domain to which the route calculating unit belongs using such topology information that is obtained by adding a topology having an abstracted route candidate of the redundant path calculated in the route decision system of the route calculation request transmission destination to the aforementioned topology information, selects a route candidate from the acquired route candidates, and issues a route calculation response, including a route that routes of the redundant path in respective route calculation domains calculated by respective route decision systems are combined together, to a request originator of the route calculation request through the route calculation request responding unit.

13. The network system according to claim 11, wherein in abstraction of the route candidate, a route candidate of a redundant path acquired from another route decision system is registered in topology information as a link with a restriction connected to a virtual end node.

14. The network system according to claim 4, wherein the reachability information is acquired by an IGP (Interior Gateway Protocol).

15. The network system according to claim 4, wherein the reachability information is acquired by an SNMP (Simple Network management Protocol).

16. A route decision system arranged correspondingly to at least one of a plurality of route calculation domains in a multi-domain network, the route decision system comprising:
a topology information collecting unit which collects topology information;
a route calculation request responding unit which receives a route calculation request requesting route calculation of a redundant path from a start node to an end node;
a route-decision-system selecting unit which selects a route calculation domain where a route decision system to which the route calculation request is to be transmitted belongs when the end node is not present in a local route calculation domain to which the route-decision-system selecting unit belongs; and
a route calculating unit which performs route calculation of the redundant path using the topology information in consideration of a restriction when the end node is present in a local route calculation domain to which the route calculating unit belongs, and issues a route calculation response including a result of the route calculation to a transmission originator of the route calculation request.

17. The route decision system according to claim 16, further comprising an interval path abstracting unit which abstracts a route calculation result included in the route calculation response, and adds the abstracted route calculation result to topology information, and wherein when the route calculation request responding unit receives the route calculation response from another route decision system, the route calculating unit causes the interval path abstracting unit to calculate a route of the redundant path using topology information that the route calculation result included in the route calculation response is abstracted and added, and issues a route calculation response including a result of the route calculation to the transmission originator of the route calculation request.

18. A method of calculating a route of a redundant path across route calculation domains from a start node to an end node by a plurality of route decision systems which are distributed and arranged in a multi-domain network and which work together, the method comprising:
a step of setting a route calculation domain through which a route from the start node to the end node passes using adjacency information retained by each route decision system; and
a step of causing a route decision system belonging to the set route calculation domain to recursively perform path calculation from a route decision system belonging to a route calculation domain where the end node is present toward a route decision system belonging to a route calculation domain where the start node is present.

19. The route calculation method according to claim 18, wherein in the step of setting a route calculation domain, a route calculation domain which can reach the route calculation domain where the end node is present among adjoining route calculation domains is sequentially selected from the route calculation domain where the start node is present.

20. The route calculation method according to claim 18, wherein in the step of setting a route calculation domain, all route calculation domains which can be passed through from the route calculation domain where the start node is present to the route calculation domain where the end node is present are selected, the step of performing path calculation is executed for each selected route calculation domain, and the route between the start node and the end node is set by comparing costs of routes of a redundant path acquired by the path calculation.

21. The route calculation method according to claim 18, wherein in the step of performing path calculation, a calculation result of a redundant path calculated in a route calculation domain which is closer to the end node than a local route calculation domain is received, and route calculation is performed using a topology in a route calculation domain that a link with a restriction to a virtual end node maintaining information on a redundant restriction is added.

22. The route calculation method according to claim 21, wherein routes from a virtual end node to each boundary node are collectively calculated as shortest tree routes for a topology to which a link with a restriction to a virtual end node is added.

23. The route calculation method according to claim 21, wherein in the step of performing path calculation, in selection of a route candidate of a redundant path, a route that a sum of a cost of a current path of the redundant path and a cost of a backup path of the redundant path becomes minimum is selected.

24. The route calculation method according to claim 21, wherein in the step of performing path calculation, in selection of a route candidate of a redundant path, a route that a cost of a current path of the redundant path is minimum is selected.

25. A non-transitory computer-readable medium storing a program that allows a computer to execute a process of calculating a route of a redundant path across route calculation domains from a start node to an end node in a multi-domain network, the program allowing the computer to execute:
a process of receiving a route calculation request requesting route calculation of the redundant path;
a process of selecting a route calculation domain where a route decision system to which the route calculation request is to be transmitted belongs when the end node is not present in a local route calculation domain to which a route decision system belongs; and
a process of performing route calculation of the redundant path in consideration of a restriction using topology information when the end node is present in the local route calculation domain to which the route decision system belongs, and of issuing a route calculation response including a result of the route calculation to a transmission originator of the route calculation request.
